(19) United States
(12) Patent Application Publication
(10) Pub. No.: US 2005/0097871 A1
(43) Pub. Date: May 12, 2005

(54) Natural air exchange planter unit

(76) Inventor: Steven P. Glassman, Marlboro, MA (US)

Correspondence Address: Steven P. Glassman, 21 Fay Court, Marlboro, MA, 01752, US

(21) Appl. No.: 10/704,947

(22) Filed: Nov. 12, 2003

(51) Int. Cl. B01D 50/00

(52) U.S. Cl. 55/385.1

(57) ABSTRACT

An improved method to enhance the air quality of a typical room, which includes:(1) A planter with air inlets and fan suction to exchange air, (2) A sealed environment that allows plants to grow and exchange air. Optionally, the cover can be removed and still achieve improved air quality. (3) Filter material that allows for a clean environment and easy maintenance of unit.

### FIELD OF INVENTION

The present invention relates to a method and apparatus to improve the air quality and aroma of a typical room.

### DESCRIPTION OF THE RELATED ART

The typical household or garden planters vary in designs from outdoor to indoor styles. They typically come in all shapes and sizes that hold numerous plants. Some added features maybe handles, and watering drain tray.

One of the most commonly used planter is the window box style planter or stand-alone style. Unfortunately from a stand point of fresh air off these indoor planters, there is no breeze to carry the fresh supply of oxygen and natural aroma generated by plants to an indoor room.

### OBJECT AND ADVANTAGES

There has been summarized above, the prior art that is related to the present invention in order that the context of the present invention maybe better appreciated.

It is an object of the present invention to provide a method and apparatus to improve the air quality and natural aroma of a typical room.

It is an object of the present invention to provide a method and apparatus that provides away to incorporate a filter system into a typical planter.

These objectives and advantages of the present invention will become readily apparent as the invention is better understood by reference to the accompanying summary, drawings and the detailed description that follows.

### SUMMARY OF THE INVENTION

The present invention is generally directed to satisfying the needs set fourth above. In accordance with the preferred embodiment, takes the form of an apparatus for improving the air quality of a typical room. This apparatus includes a clear plastic removable cover that creates a sealed environment to allow plants to grow. Air intake ports with filter material which allows filtered air passage into a sealed container. The air is then drawn into planter with negative pressure caused by outlet fan mounted on front of planter. This fan can be on a timed switch to allow on off operation for air replenishment. There will be thumbscrews mounted on top cover to allow easy access inside planter.

In another preferred embodiment, the present invention further includes an absorbent filter material configured to sit horizontally within the planter and disperse water through to the soil and prevent dirt or dust particles from escaping.

### BRIEF DESCRIPTION OF NATURAL AIR EXCHANGE UNIT

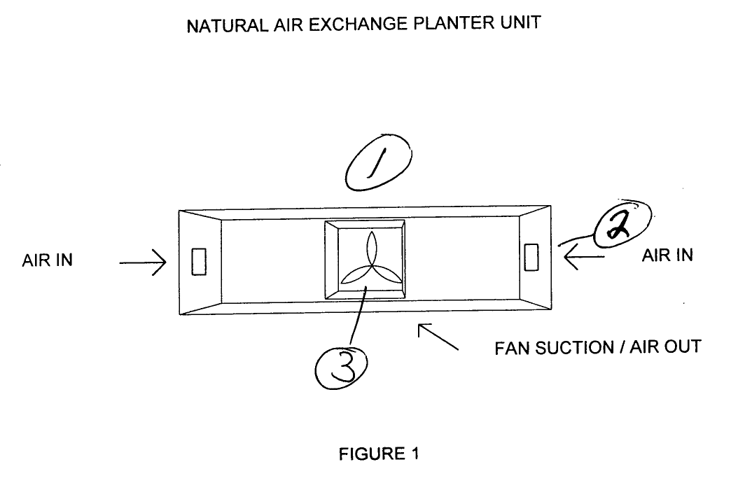

FIG. 1 Provides a perspective view of the air inlets and fan locations.

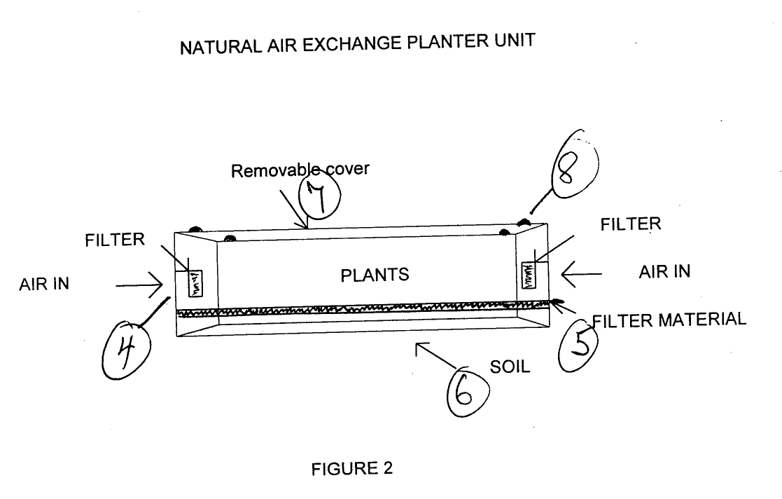

FIG. 2 Illustrates a perspective view of the filter material, plants, and removable cover.

### DESCRIPTION OF THE PREFERRED EMBODIMENT

For the purpose of explanation and not limitation, specific details set forth below in order to provide a thorough understanding of the present invention.

Referring now to the drawing, which show a preferred embodiment of the present invention and wherein like elements through reference numerals designate like elements throughout, FIG. 1 is seen to provide a perspective view of a key aspect of a preferred embodiment of the Natural Air Exchange Planter Unit 1. Illustrated in FIG. 1 the air enters either side of planter 2 which is drawn across plants by suction fan mounted in front 3. Illustrated in FIG. 2 the inlet or exhaust air can be filtered with any micron filter material 4 from there filtered air is drawn across high oxygen bearing plants, arranged between slice in filter material 5 which can vary in micron size. Material sits on top of soil 6 to allow watering and prevent dust. There is a clear removable plastic or glass cover 7 that sits on top to seal and allow sunshine through. This cover can be removed with simple thumb screws, slide or velcro 8 to allow watering or pruning.

1. A method for improving the air quality of a typical room.

2. A method to improve the common household planter.

3. A method to prevent dust in a planter using filter material or small stones.

4. A method that creates a sealed type environment that allows plants to grow and exchange air.

5. A method that allows easy access to a sealed planter environment with slide cover, thumbscrew removal, or Velcro.
